(19) United States
(12) Patent Application Publication
(10) Pub. No.: US 2015/0199713 A1
(43) Pub. Date: Jul. 16, 2015

(54) METHODS, SYSTEMS, AND APPARATUS FOR ENHANCING ELECTRONIC COMMERCE USING SOCIAL MEDIA

(71) Applicant: eBay Inc., San Jose, CA (US)

(72) Inventor: Corinne Elizabeth Sherman, San Jose, CA (US)

(21) Appl. No.: 14/588,328

(22) Filed: Dec. 31, 2014

Related U.S. Application Data
(60) Provisional application No. 61/926,820, filed on Jan. 13, 2014.

(51) Int. Cl. G06Q 30/02; G06Q 50/00

(52) U.S. Cl. CPC G06Q 30/0246; G06Q 30/0276; G06Q 30/0243; G06Q 50/01

(57) ABSTRACT

Methods, systems, and apparatus for enhancing electronic commerce using social media are described. Social media information is analyzed to determine a social media strategy and a strategy template is determined based on the defined social media strategy. The strategy template is provided to a user of an electronic commerce service.

### CLAIM OF PRIORITY

This patent application is a non-provisional of and claims the benefit of priority, to U.S. Provisional Patent Application Ser. No. 61/926,820, filed Jan. 13, 2014, which is incorporated herein by reference in its entirety.

### TECHNICAL FIELD

The present application relates generally to electronic commerce, and more specifically, in one example, to using social media to enhance electronic commerce.

### BACKGROUND

Consumers are shopping online for a growing variety of products and services and may conduct searches to locate items that are available for purchase. Consumers of products and services may generally include retail consumers, distributors, small business owners, business representatives, corporate representatives, non-profit organizations, and the like. The providers of the products and/or services may include individuals, retailers, wholesalers, distributors, manufacturers, service providers, small business owners, independent dealers, and the like. The listing for an item that is available for purchase may include a price, a description of the product and/or service, a picture of the item, and one or more specific terms for the offer.

A search for a product and/or service may produce a list of available items for purchase. A consumer may evaluate the offers and may accept an offer, reject an offer, or discard an offer. Based on sales results, the seller of the product and/or service may evaluate sales and adjust marketing efforts in an effort to increase sales.

### BRIEF DESCRIPTION OF THE DRAWINGS

Some embodiments are illustrated by way of example and not limitation in the figures of the accompanying drawings in which:

FIG. 1 is a block diagram of an example electronic commerce system for enhancing electronic commerce using social media, in accordance with an example embodiment;

FIG. 2 is a flowchart for an example electronic commerce method for listing, indexing, and searching for a product and/or service, in accordance with an example embodiment;

FIG. 3 is a block diagram of an example apparatus for utilizing social media to enhance electronic commerce, in accordance with an example embodiment;

FIG. 4 is a flowchart for an example method for enhancing electronic commerce using social media, in accordance with an example embodiment;

FIG. 5 is a flowchart for an example workflow for enhancing electronic commerce using social media, in accordance with an example embodiment;

FIG. 6 is a flowchart for a second example method for enhancing electronic commerce using social media, in accordance with an example embodiment;

FIG. 7 is a flowchart for an example workflow for enhancing electronic commerce using social media, in accordance with an example embodiment;

FIG. 8 is a flowchart for a third example method for enhancing electronic commerce using social media, in accordance with an example embodiment;

FIG. 9 is a representation of an example user interface for performing a search for a product and/or service, in accordance with an example embodiment; and

FIG. 10 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for enhancing electronic commerce using social media are described. In one example embodiment, a consumer may conduct a search for an item. As used herein, an “item” may refer to a product, a service, a combination of a product and a service, and the like. The search result set may produce a list of available items of varying degrees of relevance. The consumer may select one or more items in the search result set that may be of interest to the consumer and on which the consumer may desire to receive additional information and/or execute a transaction. An identical or similar item for sale may be located and the user may be informed of the location of the item for sale.

In one example embodiment, a strategy of a seller for using social media to promote electronic commerce may be evaluated and analyzed, and the structure of the strategy may be suggested to other sellers. A model may be generated for analyzing a strategy and defining a strategy template.

In one example embodiment, online users (known herein as “influencers”) whose online activities are monitored and followed by other online users are identified. The influencers may be able to influence their followers to purchase certain items and/or items within certain item categories. For example, a fashion designer may be able to influence fashion trends (and fashion purchases) through an online blog. In one example embodiment, the influencers are mapped to the items and/or item categories where their influence may be an effective marketing tool.

In one example embodiment, exclusive online content may be provided to a user in response to the user performing an activity. For example, a user may be granted access to a webpage comprising exclusive online content in return for “liking” a webpage on a social media website.

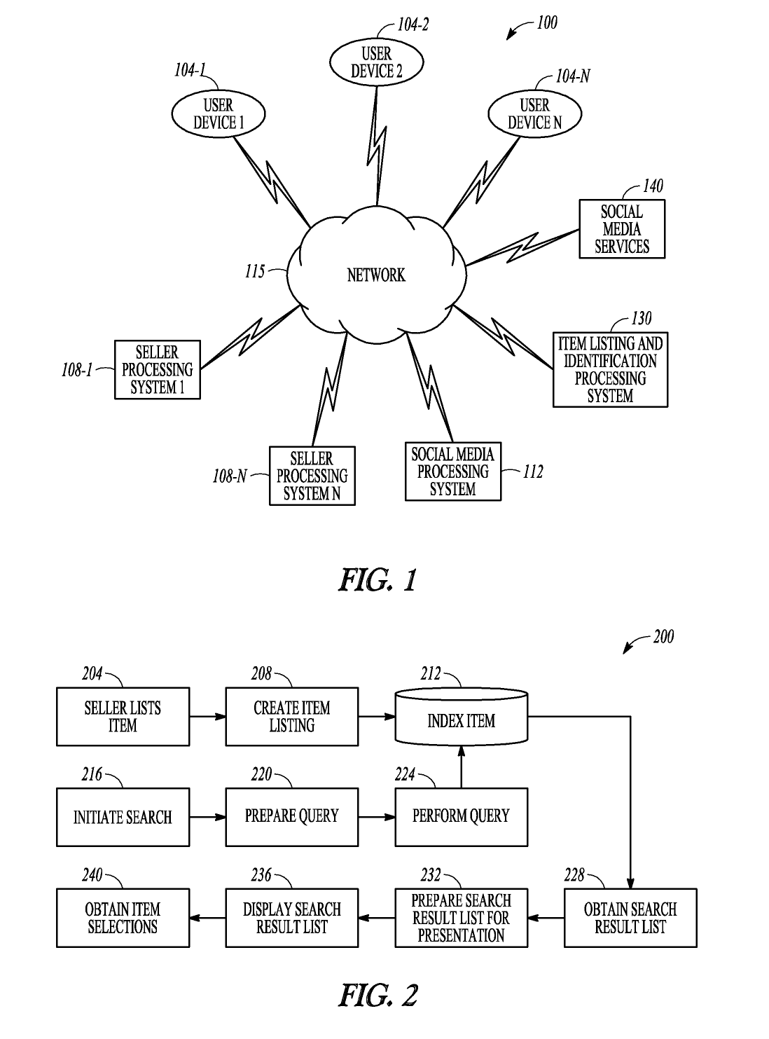

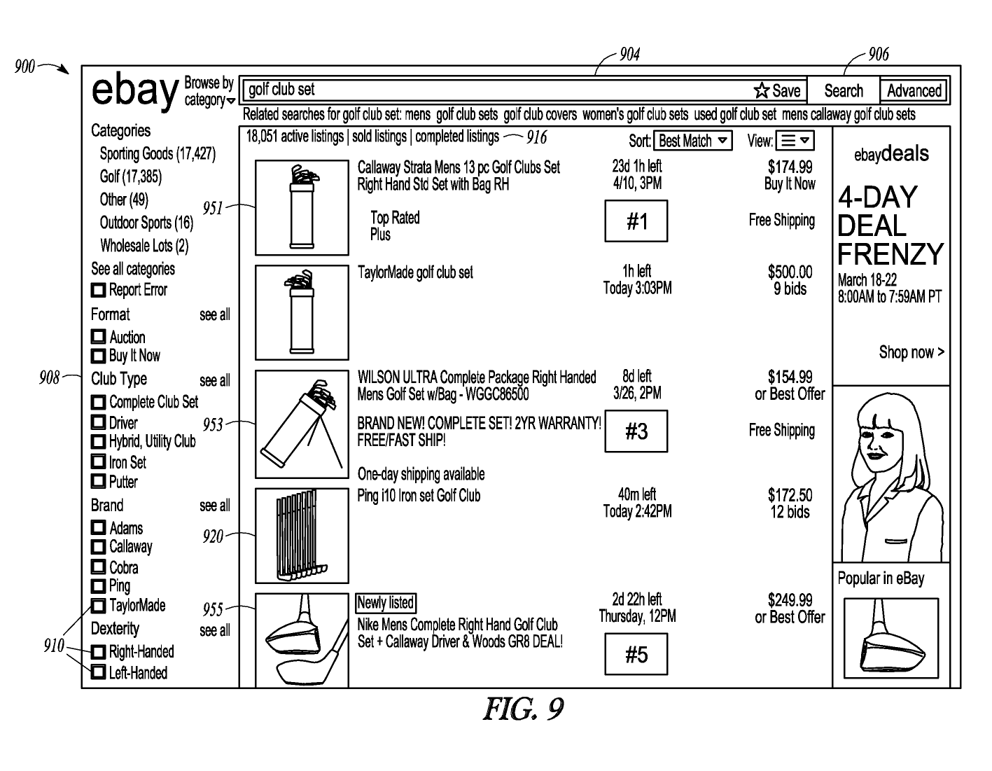

FIG. 1 is a block diagram of an example electronic commerce system 100 for enhancing electronic commerce using social media, in accordance with an example embodiment. In one example embodiment, the system 100 may include one or more user devices 104-1, 104-2 and 104-N (known as user devices 104 hereinafter), one or more optional seller processing systems 108-1, . . . , and 108-N (known as seller processing systems 108 hereinafter), one or more social media processing systems 112 (known as social media servers 112 hereinafter), an item listing and identification processing system 130, and a network 115. Each user device (e.g., 104-1) may be a personal computer (PC), a tablet computer, a mobile phone, a personal digital assistant (PDA), a wearable computing device (e.g., a smartwatch), or any other appropriate computer device. Each user device (104-1, 104-2 or 104-N) may include a user interface, described more fully below in conjunction with FIG. 9. In one example embodiment, the user device 104-1 may include a web browser program. Although a detailed description is only illustrated for user device 104-1, it is noted that each of the other user devices (e.g., user device 104-2 through user device 104-N) may have corresponding elements with the same functionality.

The optional seller processing systems 108, the social media servers 112 and the item listing and identification processing system 130 may be a server, client, or other processing device that includes an operating system for executing software instructions. The optional seller processing systems 108 may provide items for sale to a consumer, and may facilitate the search for and purchase of the items by a variety of consumers.

The social media servers 112 provide services for allowing users to socially interact. For example, the Facebook social media service, provided by Facebook Inc. of Menlo Park, Calif., USA, enables users to create personal profiles and to exchange messages with other users. The Pinterest social media service, provided by Pinterest, Inc. of San Francisco, Calif., USA, allows users to share photos in a pinboard-style format and to manage collections of images based on a common theme.

The network 115 may be may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, a network of interconnected networks, or a combination of two or more such networks, and the like.

Each user device 104 may receive a query for item information from a user via an input device such as keyboard, touchscreen, microphone, mouse, electronic pen, etc. An item may include, for example, a product and/or a service and the corresponding information may be in the form of an item listing.

The item listing and identification processing system 130 of an online listing system may store and/or obtain information related to items available for sale. Each item listing may include a detailed description for the item, a picture of the item, attributes of the item, and the like. The item associated with the item listing may be a good or product (e.g., a tablet computer) and/or service (e.g., a round of golf or appliance repair) that may be transacted (e.g., exchanging, sharing information about, buying, selling, making a bid on, and the like). The item listing may also include a title, a category (e.g., electronics, sporting goods, books, antiques, and the like), and attributes and tag information (e.g., color, size, and the like).

Referring back to the user device 104-1, the query received from the user of user device 104-1 may include one or more keywords. The user device 104-1 may transmit the query to the item listing and identification processing system 130 via the network 115. The item listing and identification processing system 130 may attempt to match the query keywords with the title, the category, the tag information, and/or any other field in the item listing using a search engine.

In response to the submission of the search query, the item listing and identification processing system 130 may attempt to identify one or more item listings that satisfy the query. The item listing and identification processing system 130 may retrieve and then sort the item listings in the search result in a known manner. The item listing and identification processing system 130 may then return a sorted search result list to the user device 104-1 that submitted the query. The consumer may select one or more items in order to obtain additional information on the item and/or purchase the item.

FIG. 2 is a flowchart for an example electronic commerce method 200 for listing, indexing, and searching for a product and/or service, in accordance with an example embodiment. In one example embodiment, a seller may list an item for sale (operation 204). The seller may, for example, select a category for the item, submit a description of the item, submit a picture of the item, manually set attributes of the item, and the like.

An item listing may be created, for example, in an item listing database (operation 208). The listing may include, for example, attributes of the item and terms of the sale offer. During the item listing operation 208, an identification number for the item listing may be assigned, and the listing may be authenticated and scanned to check for conformance with one or more listing policies. The listed item may be indexed (operation 212) in a known manner to facilitate future searches for the item.

A consumer may launch a search or query for one or more items (operation 216). For example, a consumer may initiate a search using the keywords “golf clubs.” A corresponding query may be prepared (operation 220). For example, a spell check may be performed on the query terms and a search expression may be generated based on the provided search terms.

The query may be executed on, for example, the items that have been indexed in the system (operation 224). For example, the prepared query may be matched against the index that was updated during operation 212.

In response to the execution of the query, a search result list may be obtained (operation 228). The search result list may be prepared for presentation (operation 232). For example, the search result list may be filtered, sorted, ranked and/or formatted based, for example, on an analysis of the search result list.

The prepared search result list may be displayed (operation 236). In response to reviewing the displayed search result list, one or more item selections from one or more displayed item pages may be obtained from a user (operation 240).

In one example embodiment, social media is used as a mechanism to direct consumers and other users to an electronic commerce service. For example, a user may encounter a product and/or services on social media on which the user may desire to obtain more information and, possibly, may desire to purchase.

In one example embodiment, the electronic commerce service may want to share information with a user regarding a topic, a social interest, a product, a service, and the like. For example, the electronic commerce service may determine that the topic, social interest, product, and/or service is of interest to the user and may offer to share unique content related to the topic, social interest, product, and/or service with the user.

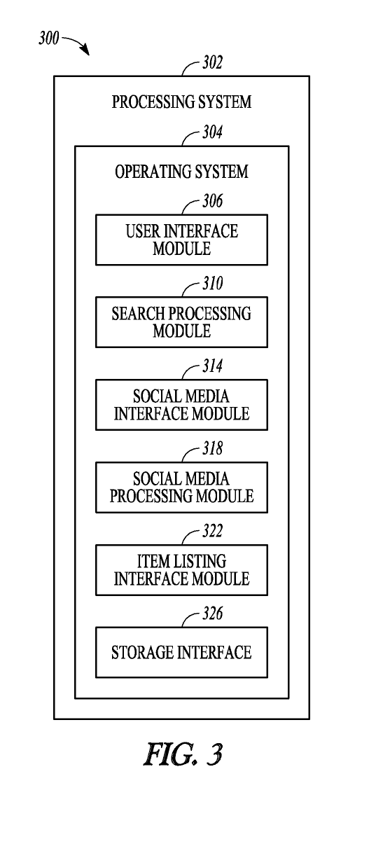

FIG. 3 is a block diagram of an example apparatus 300 for utilizing social media to enhance electronic commerce, in accordance with an example embodiment. The apparatus 300 is shown to include a processing system 302 that may be implemented on a client or other processing device that includes an operating system 304 for executing software instructions.

In accordance with an example embodiment, the apparatus 300 may include a user interface module 306, a search processing module 310, a social media interface module 314, a social media processing module 318, and an item listing interface module 322. In accordance with an example embodiment, the apparatus 300 may further include a storage interface 326.

The user interface module 306 may obtain search criteria from a user (consumer), may present a search result list to a user, may obtain item selections from a user, and may present an item listing to a user. The user interface module 306 may provide a user interface, as described more fully below in conjunction with FIG. 9.

The search processing module 310 may submit a query to the item listing and identification processing system 130 and may obtain a search result list from the item listing and identification processing system 130.

The social media interface module 314 may interface with one or more social media services 140 to, for example, contact prospective consumers, obtain information on users, and obtain strategies from electronic commerce sellers. The social media processing module 318 may, for example, analyze selling strategies of electronic commerce sellers and define a template for an electronic commerce strategy.

The item listing interface module 322 may interface with the item listing and identification processing system 130 to obtain information related to items available for sale.

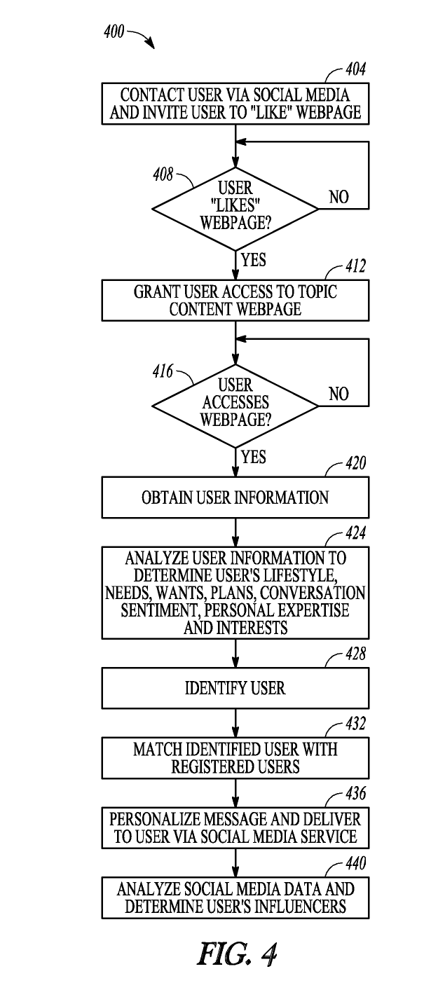

FIG. 4 is a flowchart for an example method 400 for enhancing electronic commerce using social media, in accordance with an example embodiment. In one example embodiment, the method 400 may be performed by the social media processing module 318.

In one example embodiment, a user may be sent an invitation to “like” a page on a social media service 140 (operation 404). For example, the user may be sent electronic mail containing an invitation to “like” a webpage sponsored by an electronic commerce provider on the social media site of Facebook Inc. of Menlo Park, Calif., USA. The Facebook page may be designed to share content that may be related to one or more topics of interest to the user. For example, the Facebook page may contain content, such as reviews of fashion designers; reviews of fashion design items, such as dresses, shoes, handbags; and the like. In one example embodiment, a user may only have access to the cited content if the Facebook page is “liked” by the user.

The content may also provide useful information to the consumer. For example, the content may contain product review information for a tablet computer. The user may read the content and thereby enhance the user's opinion of the competence of the electronic commerce provider regarding the related topic. The electronic commerce provider may thereby become a trusted service provider to the user for information and items related to the topic.

In one example embodiment, a test may be performed to determine if the user has performed the “like” operation (operation 408). If the user has not performed the “like” operation, the method may repeat operation 408; otherwise, the user may be granted access to the exclusive content (operation 412). For example, a link to a webpage of the electronic commerce provider may be presented to the user. A selection of the link by the user may direct the user to, for example, a website of the electronic commerce provider. The website may provide access to the exclusive content.

In one example embodiment, a test may be performed to determine if the user has accessed the exclusive content (operation 416). If the user has not accessed the exclusive content, the method may repeat operation 416; otherwise, information related to the user may be obtained (operation 420). For example, the electronic commerce provider may gather information from various social media services 140, including from the social media service 140 that hosted the exclusive content webpage.

In one example embodiment, the user information and social media information may be analyzed and used in a marketing activity (operation 424). For example, a user's search behavior, purchase behavior, tweets, postings, pinnings, and the like, may be analyzed to determine a user's lifestyle, needs, wants, plans, conversation sentiment, interests, personal expertise, and the like. The marketing activity may be performed by the social media processing module 318.

In one example embodiment, the user may be identified (operation 428) and matched to the user's identity registered with or otherwise known to the electronic commerce provider (operation 432). For example, the customer's identity and/or Facebook profile may be matched to the user's identity registered with or otherwise known to the electronic commerce provider. The user may only be required to sign-in, register with or access the social media site in order to be recognized by the electronic commerce provider.

In one example embodiment, the social media information may be processed to learn about the consumer. For example, tweets associated with the user, such as tweets generated by the user, may be processed and mined to find reactions, complaints, interests, and the like, expressed by the user.

In one example embodiment, the mined data may be used to contact the user (operation 436). For example, the mined data may be used to personalize electronic mail, marketing information, and the like. The user may be contacted via various social media services 140. In one example embodiment, the particular social media service 140 that may be used to contact the user may be based on the type of item under consideration.

In one example embodiment, publicly available data related to the user may be gathered from one or more social networking services, such as the social media service 140 of Facebook Inc. of Menlo Park, Calif., USA. The publicly available data may include work experience, education history, gender, travel locations, home locations, friends, associated groups, notes, and the like. The publicly available data may also include what the user likes, such as brands, music, movies, TV shows, books, interests, activities, athletes, sports teams, and various “likes.” The obtained data may be mined to learn more about the user. For example, a user's lifestyle, needs, wants, weekend plans, conversation sentiment, personal expertise and interests, links to favorite blogs and sites, frequency of social activity, key conversations via hashtag use, social interactions with eBay, brands, leaders, and friends may be obtained or determined from the mined data.

In one example embodiment, the search behavior of a user may be obtained. For example, product searches on an electronic commerce marketplace, such as the electronic commerce marketplace of eBay Inc. of San Jose, Calif., may be obtained. In addition, the search behavior of a user may be obtained by analyzing a browsing history, referral channel, and the like, that is associated with the user. In one example embodiment, the purchase behavior of a user may be obtained.

In one example embodiment, the social information may be also utilized to determine the user's influencers (operation 440). Influencers are people, magazines, websites, blogs, and the like, who may influence the user in regard to purchases, interests, desires, and the like.

In one example embodiment, an influencer may be identified by analyzing social media. For example, one or more tweets published on the Twitter service of Twitter Inc. of San Francisco, Calif., USA may be analyzed by searching for a particular keyword, such as “handbags”, or by searching for the keyword and a number of synonyms of the keyword. An influencer may be recognized by one or more of: 1) a number of tweets related to a topic; 2) an accuracy of a hashtag for a topic; 3) a percentage of tweets from the influencer that are re-tweeted by other users; 4) an average count of re-tweets of the influencer's original tweet; 5) a count of occurrences of a tweet; 6) an accuracy of a tweet; and the like.

In one example embodiment, categories and/or topics may be ranked. For example, topics may be ranked according to revenue, potential revenue, revenue growth, profit, a volume of social media mentions, an inventory level (where the topic is a product), success metrics, and the like. Popular products may be ranked by one or more of: 1) page views (single page views and multiple page sessions); 2) user operations such as bid, bin, offer, watch, and ask a question (BBOWA); 3) a ratio of page views of an item per brand, category level, or product vertical; 4) top sellers; 5) BBOWA per page view; 6) product attribute(s); 7) product brand; 8) product level (e.g., L3); 9) meta-category (e.g., L1); 10) popularity of type of product; and the like. Externally, twitter may be mined for product mentions, a count of share operations outbound to a social network, an amount of inbound traffic from a social network, a type of traffic (e.g., organic (originating from the electronic commerce service) or referral (originating from outside the electronic commerce service), and the like.

The categories associated with the most popular products, for example, may be determined. The influencers associated with the product(s), the domain(s) of the product(s), and/or the category of the product(s) may be identified and their services may be utilized to market the product. In one example embodiment, the influencers may be ranked by, for example, the amount of user traffic that they generate for an electronic commerce service provider. For example, the influencers may be ranked by an amount of traffic that they generate to a website provided by an electronic commerce provider.

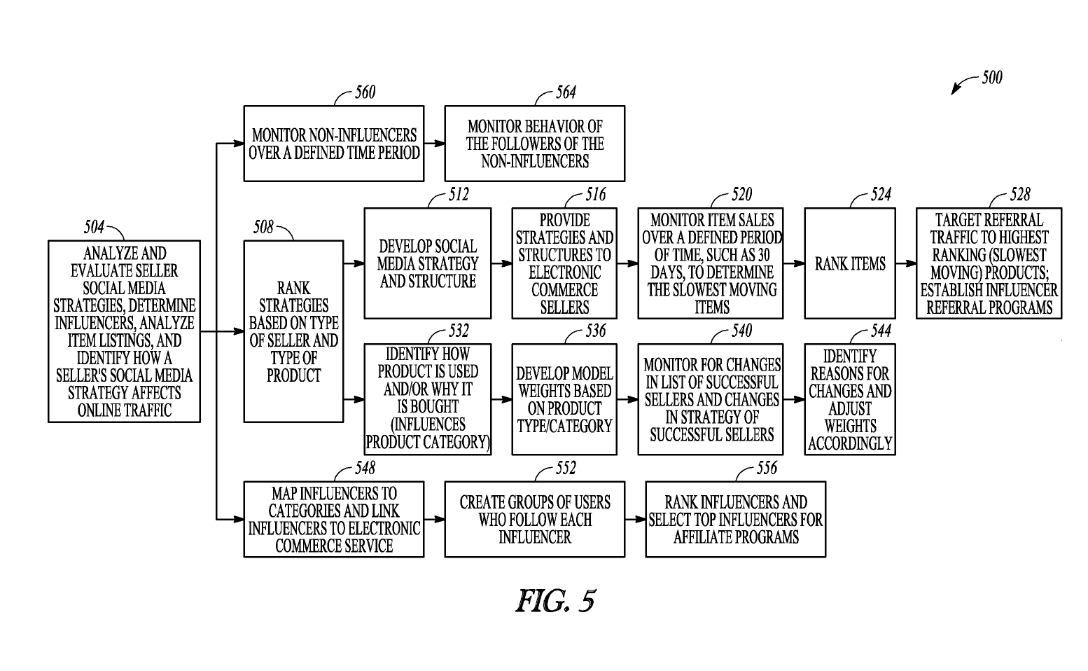

FIG. 5 is a flowchart for an example workflow 500 for enhancing electronic commerce using social media, in accordance with an example embodiment. In one example embodiment, strategies for enhancing electronic commerce using social media may be evaluated and one or more highest-ranking strategies may be provided to a seller using an electronic commerce service.

In one example embodiment, social media may be evaluated and analyzed to determine strategies for conducting electronic commerce and/or for identifying users (known herein as “influencers”) whose social media activities influence other users (operation 504). For example, tweets by users, including sellers and/or known influencers, may be analyzed to determine which tweets and/or users generate the most completed transactions or that generate referrals that lead to the greatest number of purchases. (A transaction may be, for example, a transaction to purchase an item via an electronic commerce provider.) The influencers who made the cited referrals may be identified. Similarly, retweets of users, including sellers and/or known influencers, may be analyzed. In one example embodiment, various social media instruments, such as chat patterns, postings on social media sites such as Facebook, the pinning of pictures on social media sites such as Pinterest, and the like, may be monitored to understand the social media activities of users and may be used to identify users who may be influencers. Once identified, the social media activities and long-term behavior of influencers may be analyzed to evaluate their effectiveness in driving online traffic and electronic commerce transactions. The social media activities of the influencers may be analyzed over the short-term, such as in conjunction with a sales promotion, and/or may be analyzed over the long-term to characterize the long-term behavior of the influencer. In one example embodiment, the item listings, and the strategy and social media activities of successful sellers may be analyzed to evaluate social media strategies for driving electronic commerce. The online traffic and electronic commerce transactions resulting from the social media strategies may be measured to provide a strategy score for one or more of the social media strategies.

In one example embodiment, the social media strategies may be ranked based on the evaluation (operation 508). For example, the strategy score may be used to rank the social media strategies. The social media strategies may be ranked by type of seller and/or type of product.

In one example embodiment, one or more of the ranked strategies may be analyzed to define a structure and/or template for the social media strategy (operation 512). For example, the top-ranking social media strategies may be analyzed to define a template for the social media strategy that may be used to replicate the strategy by other users. In one example embodiment, the structure(s) of tweet(s) associated with a social media strategy are evaluated and a tweet template is generated. For example, a template of the tweets that lead to the most completed transactions may be generated. A tweet template may comprise, for example, a positive phrase, an intriguing question, a number of hashtags, media or twitter content, a web link, a brand (with a web link to the brand), and the like. An instagram template may comprise, for example, an eye-catching photograph, an appropriate hashtag, and the like. A template for a posting on Facebook may comprise, for example, a sentence that can be marked as “likeable” by a Facebook user, media content, a “call to action” (e.g., a web link to follow), and the like.

Similarly, postings on Facebook and pinnings on Pinterest may be analyzed and a structure of the examples that lead to the most completed transactions may be defined. In another example, an item listing may be published on one or more social media services, such as Facebook, Twitter, Pinterest, and the like.

In one example embodiment, one or more of the developed social media strategies and their corresponding structure(s) may be provided to a user (operation 516). For example, a strategy for promoting the sale of handbags via social media and a template for the strategy, such as a template for a promoted tweet, may be provided to a seller on an electronic commerce site. In one example embodiment, natural language processing is used to analyze a social media posting.

In one example embodiment, items may be monitored over a defined period of time, such as 30 days, to determine the slowest moving (i.e., slowest selling) items (operation 520). For example, the inventory level of a particular item available for sale may be divided by the total number of page views for the item during the defined period of time. A ratio below a predefined threshold may be interpreted as indicating a slow moving item. The monitored items may be ranked (operation 524). For example, the monitored items may be ranked by sales, where the items with the lowest sales are ranked highest.

In one example embodiment, online traffic may be directed to the slowest selling items (operation 528). For example, an identified influencer may be enrolled in a referral program where the influencer is rewarded for generating referral traffic to an item listing and/or to an online store associated with the item listing. In one example embodiment, the referral traffic for a slow moving item may be targeted for increase.

In one example embodiment, a product may be selected and analyzed to determine how the product is used and to determine why it is typically purchased by a consumer (operation 532). For example, a handbag may be purchased because it is currently in style, because it is used by a celebrity, and/or because it is revered by a fashion critic.

In one example embodiment, one or more strategy model weights may be determined (operation 536). For example, one or more model weights may be determined for the selected product and/or associated product type or category. The strategy model may model, for example, a general electronic commerce selling and marketing strategy and may be used for analyzing selling and marketing strategies of sellers, including influencers, and for defining strategy templates.

In one example embodiment, changes in which users are influencers, changes in which users are successful at generating transactions, and/or changes in which strategies are successful are monitored (operation 540). For example, successful item listings for watches may be primarily image based, reflecting that appearance and style are important aspects of the item listing. A change to text based item listings may be detected. Analysis may show, for example, that the transition to text-based listings coincided with a transition in the marketplace to smartwatches. Thus, in one example embodiment, in response to detecting a change in a successful social media strategy, the reason(s) for the change are identified and the model weights for a corresponding product or product type may be adjusted to reflect an emphasis on text-based listings (operation 544).

In one example embodiment, the influencers that have been identified may be mapped to one or more item categories and the influencers may be linked to an electronic commerce service (operation 548). For example, an influencer may be mapped to a product category, such as cars, handbags, and the like; may be mapped to a type of influencer, such as celebrity, critic, and the like; and may be mapped to a category based on the influencer's followers, such as college students, wine enthusiasts, athletes, and the like. The categories may correspond to categories of the electronic commerce provider. For example, the categories may correspond to categories of products listed for sale on the electronic commerce service.

In one example embodiment, an influencer may be linked to the electronic commerce service. For example, the influencer may be linked to a store on the electronic commerce service owned and/or operated by the influencer.

In one example embodiment, the users that follow an identified influencer may be segmented into a group (operation 552). For example, users who re-tweeted, favorited, followed, and the like a particular influencer may be identified and the identified users may be assigned to a group. The group may then, for example, be jointly marketed to. The group may comprise all of the followers of the influencer, or may comprise a subset of the followers of the influencer. The group may be further segmented. For example, a group of followers of an influencer may be further segmented according to demographics, such as college students, wine enthusiasts, athletes, and the like.

In one example embodiment, the influencers may be ranked and a referral program with an influencer, such as an affiliate program, may be established (operation 556). For example, the influencers may be ranked by the amount and type (e.g., based on demographics and psychographics) of referral traffic that they generate, by a count of new users and/or reactivated users that the influencer generates, by a count of followers, by the amount of time spent by a referred user prior to executing a transaction, by the behavior and interactions of a referred user, and the like.

In one example embodiment, the referral program may award an influencer for generating referral traffic to an item listing, an online store, and the like. For example, an influencer may issue a tweet that will generate traffic to the item listings for the slowest moving items on an electronic commerce marketplace. The tweet may be structured based on the tweet analysis cited above. In one example embodiment, an incentive commensurate with the influencer's level of influence may be offered to the influencer to issue a tweet. The incentive may be based, for example, on a frequency of purchases by a user(s); an amount of money spent on products and/or services; and the like.

### Monitoring Non-Influencers

In one example embodiment, the social activities of users determined to be non-influencers may be monitored (operation 560). Non-influencers may be users whose social media activities influence a number of users below an influence threshold and who have limited engagement or interaction with other users. For example, a user whose tweets are followed by only twenty friends may be categorized as a non-influencer. In one example embodiment, non-influencers may need to provide keywords for searches to determine the non-influencers that drive the most traffic and/or G&B.

Furthermore, tweets by users who are non-influencers may be analyzed and a structure of the tweets that lead to the most completed transactions may be provided to users who are also non-influencers. In one example embodiment, the number of visits of each of the cited users, the identity of the users who made a purchase and the amount of the purchase, the network that the user came from, the identities of the users who shared, and the like, may be tracked. The tracking may be performed for traffic and/or the amount of gross merchandise bought (GMB). The total GMB may be computed to determine a value of the activity to the electronic commerce provider.

In one example embodiment, the social activities and electronic commerce activities of users who follow non-influencers may be monitored (operation 564).

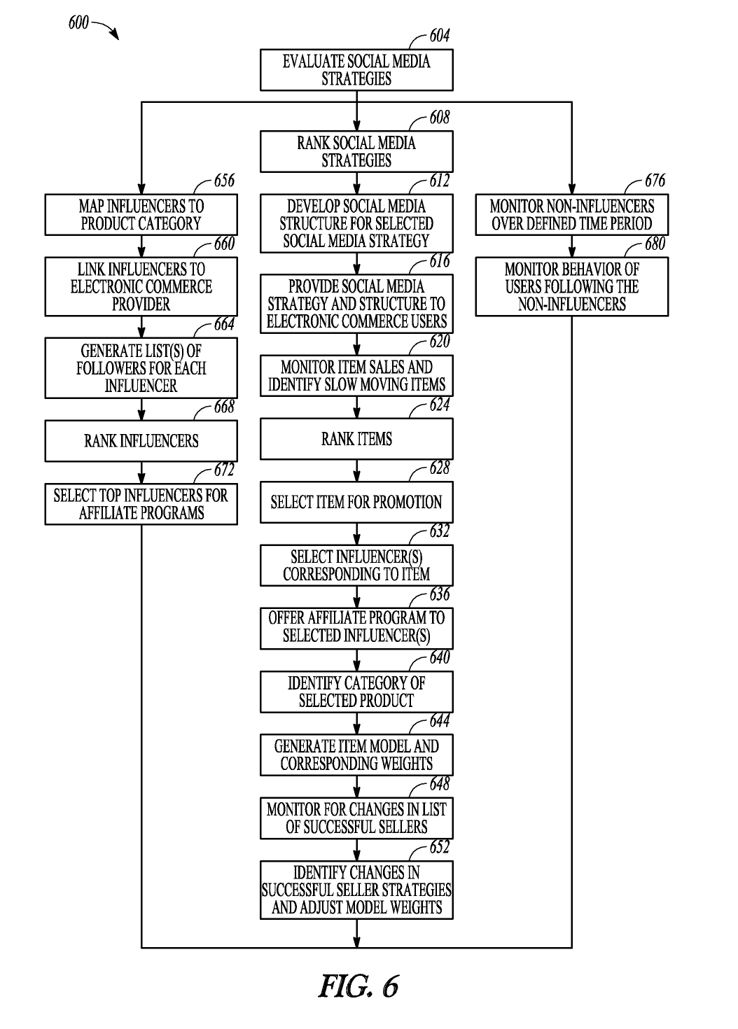

FIG. 6 is a flowchart for a second example method 600 for enhancing electronic commerce using social media, in accordance with an example embodiment. In one example embodiment, strategies for enhancing electronic commerce using social media may be evaluated and one or more highest-ranking strategies may be provided to a seller using an electronic commerce service.

In one example embodiment, social media may be analyzed to determine strategies for conducting electronic commerce and/or for identifying users (known herein as “influencers”) whose social media activities influence other users (operation 604). For example, tweets by users, including sellers and/or known influencers, may be analyzed to determine which tweets and/or users generate the most completed transactions or that generate referrals that lead to the greatest number of transactions. The influencers who made the cited referrals may be identified. (A transaction may be, for example, a transaction to purchase an item via an electronic commerce provider.) Similarly, retweets of users, including sellers and/or known influencers, may be analyzed. In one example embodiment, various social media instruments, such as chat patterns, postings on social media sites such as Facebook, the pinning of pictures on social media sites such as Pinterest, and the like, may be monitored to understand the social media activities of users and may be used to identify users who may be influencers. Once identified, the social media activities of influencers may be analyzed to evaluate their effectiveness in driving online traffic and electronic commerce transactions. The social media activities of the influencers may be analyzed over the short-term, such as in conjunction with a sales promotion, and may be analyzed over the long-term to characterize their long-term behavior. In one example embodiment, the item listings and the strategy and social media activities of successful sellers may be analyzed to evaluate social media strategies for driving electronic commerce. The online traffic and electronic commerce transactions resulting from the social media strategies may be measured to provide a strategy score for one or more of the social media strategies.

In one example embodiment, the social media strategies may be ranked based on the evaluation (operation 608). For example, the strategy score may be used to rank the social media strategies. The social media strategies may be ranked by type of seller and/or type of product.

In one example embodiment, one or more of the ranked strategies may be analyzed to define a structure and/or template for the social media strategy (operation 612). In one example embodiment, the structure(s) of tweet(s) associated with a social media strategy are evaluated and a tweet template is generated. For example, a structure of the tweets that lead to the most completed transactions may be generated. The tweet template may comprise a recommended structure of the tweet, a character and/or tone (e.g., a sentiment) of the tweet, a type of tweet (e.g., statement, question, and the like), a type of “call to action” (e.g., a suggestion to visit a website), a specific “call to action” (e.g., follow a provided web link), and the like.

Similarly, postings on Facebook and pinnings on Pinterest may be analyzed and a structure of the examples that lead to the most completed transactions may be defined. For example, a structure may comprise a picture pinned on Pinterest and a sharing of the pinning on Facebook and/or Twitter. The type of share may be based on the product, the seller, the target social network(s), the target audience, the “call to action”, the purpose, and the like. In one example, a pinning on Pinterest may include hashtags (e.g., #bracelet, #fashion, #collegegirls) and the statement: “this is so convenient and stylish! This is the must have bracelet to carry the necessities on campus.” In another example, an item listing may be published on one or more social media services, such as Facebook, Twitter, Pinterest, and the like.

In one example embodiment, one or more of the developed social media strategies and their corresponding structure may be provided to a user (operation 616). For example, a strategy for promoting the sale of handbags via social media and a structure for the strategy, such as a structure for a promotional tweet, may be provided to a seller on an electronic commerce site.

In one example embodiment, items may be monitored over a defined period of time, such as 30 days, to determine the slowest moving (i.e., slowest selling) items (operation 620). In one example, repeated views of the item (e.g., website page views); purchases of the item; user operations such as bid, bin, offer, watch, and ask a question (BBOWA) associated with the item; and the like may be used to determine a slow moving item. In one example, the inventory level of a particular item available for sale may be divided by the total number of page views for the item during the defined period of time. A ratio below a predefined threshold may be interpreted as indicating a slow moving item. The monitored items may be ranked (operation 624). For example, the monitored items may be ranked by sales, where the items with the lowest sales are ranked first (i.e., highest).

In one example embodiment, an item may be selected for promotion (operation 628). For example, an item may be selected for the targeting of online traffic by an influencer.

One or more influencers corresponding to the selected item may be selected (operation 632). For example, an influencer who has been identified as being influential in connection with the selected item may be identified.

An affiliate program may be offered to the selected influencers (operation 636). The influencer may be rewarded for generating referral traffic to an item listing and/or to an online store associated with the item listing. In one example embodiment, the referral traffic for a slow moving item may be targeted for increase.

In one example embodiment, one or more categories may be identified for the selected product (operation 640). A model for the item and corresponding model weights may be generated (operation 644). For example, one or more model weights may be determined for the selected product and/or associated product type or category.

In one example embodiment, the strategies of successful sellers may be monitored (operation 648). For example, changes in which users are influencers, changes in which users are successful at executing transactions, and/or changes in which strategies are successful are monitored. For example, successful item listings for watches may be primarily image based, reflecting that appearance and style are important aspects of the item listing. A change to text based item listings may be detected. Analysis may show, for example, that the transition to text-based listings coincided with a transition in the marketplace to smartwatches.

Thus, in one example embodiment, in response to detecting a change in successful social media strategies, the model weights for a corresponding product or product type may be adjusted (operation 652).

### Affiliate Programs

In one example embodiment, the influencers that have been identified may be mapped to one or more categories (operation 656). For example, an influencer may be mapped to a product category, such as cars, handbags, and the like; may be mapped to a type of influencer, such as celebrity, critic, and the like; and may be mapped to a category based on the influencer's followers, such as college students, wine enthusiasts, athletes, and the like. The categories may correspond to categories of the electronic commerce provider. For example, the categories may correspond to categories of products listed for sale on the electronic commerce service.

In one example embodiment, an influencer may be linked to the electronic commerce provider (operation 660). For example, the influencer may be linked to a store on the electronic commerce service owned and/or operated by the influencer.

In one example embodiment, the users that follow an identified influencer may be segmented into a group (operation 664). For example, users who re-tweeted, favorited, followed, and the like a particular influencer may be identified and the identified users may be assigned to a group that, for example, may be jointly marketed to. The group may comprise all of the followers of the influencer. The group may be further segmented. For example, a group of followers of an influencer may be further segmented according to demographics, such as college students, wine enthusiasts, athletes, and the like.

In one example embodiment, the influencers may be ranked (operation 668). For example, the influencers may be ranked by the amount of referral traffic that they generate, by a count of followers, a count of conversations the influencer generates, a count of engagements regarding the associated company and/or product, the value of the insight generated by the generated communications, a count of “likes” on Facebook, a count of retweets on Twitter, postings on a blog or in an article as a result of or in affiliation with the influencer, and the like.

In one example embodiment, a referral program, such as an affiliate program, may be offered to the top-ranking influencer(s) (operation 672). The referral program may reward an influencer for generating referral traffic for an item listing, an online store, and the like. For example, an influencer may issue a tweet that will generate traffic to the item listings for the slowest moving items on an electronic commerce marketplace. The tweet may be structured based on the tweet analysis cited above. In one example embodiment, an incentive commensurate with the influencer's level of influence may be offered to the influencer to issue a tweet.

### Monitoring Non-Influencers

In one example embodiment, the social activities of users determined to be non-influencers may be monitored over a defined time period (operation 676). Non-influencers may be users whose social media activities influence a number of users below an influence threshold. For example, a user whose tweets are followed by only twenty friends and who has limited engagement or interaction with other users may be categorized as a non-influencer. In one example embodiment, non-influencers may need to provide keywords for searches to determine the non-influencers that drive the most traffic and/or GMB.

Furthermore, tweets by users who are non-influencers may be analyzed and a structure of the tweets that led to the most completed transactions may be provided to other users who are non-influencers. In one example embodiment, the number of visits of each of the cited users, the identity of the users who made a purchase and the amount of the purchase, the network that the user came from, the identity of the users who shared, and the like may be tracked. The tracking may be performed for traffic and/or G&B's. The total G&B may be computed to determine a value of the activity to the electronic commerce provider.

In one example embodiment, the social activities and electronic commerce activities of users who follow non-influencers may be monitored (operation 680).

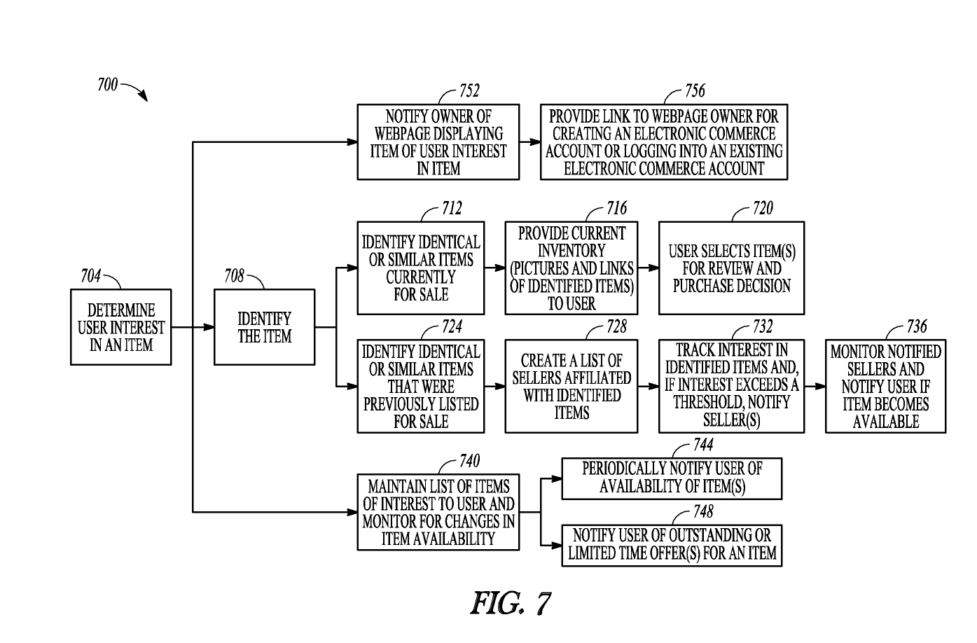

FIG. 7 is a flowchart for an example workflow 700 for enhancing electronic commerce using social media, in accordance with an example embodiment.

In one example embodiment, a user who encounters an online item, such as a picture of an item, may indicate an interest in the item, such as an interest in purchasing the item (operation 704). For example, the user may select a radio button when the item is displayed to indicate an interest in purchasing the item or the user may double-click on the item using a mouse. If more than one item appears in the picture, the user may highlight, select or otherwise indicate the desired item in the picture. In one example embodiment, a page displaying multiple items is crawled and each item is displayed individually in a pop-up window for the user. The user may select the desired item when it appears in the pop-up window.

Similarly, a user who encounters an online item, such as a picture of an item, may be offered the ability to indicate an interest in selling the item. For example, the user may select a radio button when the item is displayed to indicate an interest in selling the item. If more than one item appears with the desired item, the user may highlight, select or otherwise indicate the desired item.

In one example embodiment, the selected item may be identified (operation 708). For example, image recognition may be utilized to analyze the image of the item and identify the item. In one example embodiment, social media associated with users discussing the item may be crawled to seek information that may be useful in identifying the item. For example, a user's description of the item, an identification of a store where the item is available, and the like, may be processed to seek information that may be useful in identifying the item.

In one example embodiment, a search may be conducted for items that are currently for sale and are the same as, similar to and/or equivalent to the selected item (operation 712). In response, a list of items available for sale may be returned and may be presented to the user (operation 716). The user may review the item listing and may purchase one or more of the presented items (operation 720).

In one example embodiment, a search may be conducted for items that were available for sale in the past and that are the same as, similar to and/or equivalent to the selected item (operation 724). A list of the seller(s) associated with the items identified in operation 724 may then be generated (operation 728). The list may include an identification of the item and a count of users who have expressed an interest in purchasing the item during operation 704.

Interest in the identified item(s) may be tracked and one or more sellers of the item(s) may be notified if an interest in the item(s) exceeds an interest threshold (operation 732). For example, electronic mail describing the item of interest and a count of users who have expressed interest in purchasing the item may be sent to one or more of the sellers on the generated list. The communication may include a suggested price or price range for the item. The identities of a number of users that indicated an interest in purchasing the item may be aggregated into a single communication and provided to one or more sellers. For example, the identities of the users that indicated an interest in purchasing the item may be provided to store owners registered with an electronic commerce service.

If an inventory of a seller has been updated to include the cited item, a user who expressed interest in an item may be informed of the availability of the item for purchase (operation 736). For example, if a seller begins offering the item for sale after the user has expressed interest in the item, a notification may be sent to the user. The notification may include the name of the seller, a link to a webpage where the item may be purchased, a description of the item, a price of the item, terms of the offer, and the like.

In one example embodiment, a list of items desired by a user may be maintained and changes in an availability of the item may be monitored (operation 740). The user may be periodically notified of an availability of desired items (operation 744). The notification may be via electronic mail, electronic text, and the like. The communication may include the name(s) of one or more items, a description of the one or more items, one or more pictures of the one or more items, and the like. In one example embodiment, the communication may include a link to a webpage that indicates all of the items that a particular user has indicated an interest in purchasing. For example, the webpage may show a picture of each item. The user may select one of the items to obtain information on purchasing the corresponding item and/or obtain information on purchased items.

The communication may be sent each time a predefined number of items have been identified by the user, may be sent at a time based on a frequency of a user's purchases, a frequency of the user's online activities, and the like.

In one example embodiment, a statistical model may be used to determine when the communication should be sent. For example, the statistical model may be used to determine if the communication should be sent periodically and/or should be sent when one or more of the items is available for sale at a special price. In one example embodiment, a user is notified of an outstanding and/or limited time offer for a desired item (operation 748).

In one example embodiment, the owner of the webpage that contains the item of interest to the user may be notified of the user's interest in the item (operation 752). For example, the owner may be notified via electronic mail that the user is interested in the item. In one example embodiment, the owner of the webpage is only notified if the owner is a qualified owner. For example, the owner of the webpage may only be notified if the owner is a non-competitor of the notifier. In one example embodiment, the owner of the webpage is only notified if a minimum interest threshold is exceeded. For example, the owner of the webpage may only be notified if the number of users who have expressed an interest in the item exceeds a predefined threshold.

In one example embodiment, the notification to the owner of the webpage may contain a mechanism for the owner to list the item for sale (operation 756). For example, the notification may include a link to an electronic commerce service provider for creating an account with the electronic commerce service provider. In one example embodiment, a recommended item listing may be proposed to the owner of the webpage.

The item may be identified by analyzing an image of the item. In one example embodiment, social media associated with the users discussing the item may be crawled to seek information that may be useful in identifying the item. For example, a user's description of the item, an identification of a store where the item is available, and the like, may be processed to seek information that may be useful in identifying the item.

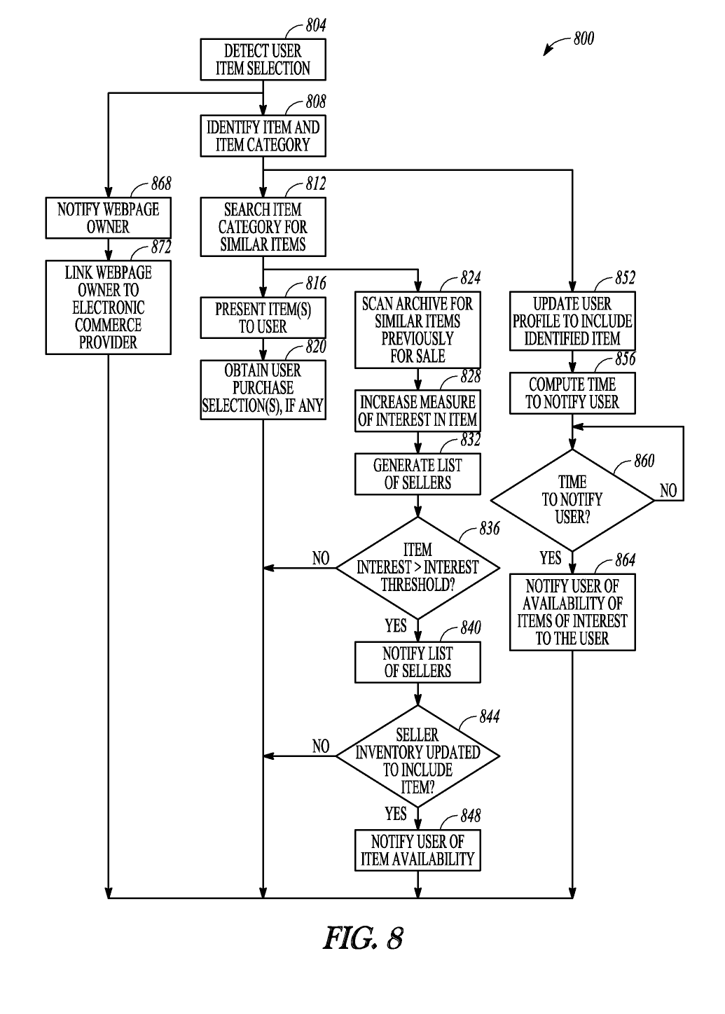

FIG. 8 is a flowchart for a third example method 800 for enhancing electronic commerce using social media, in accordance with an example embodiment.

In one example embodiment, a user who encounters an online item, such as a picture of an item, may indicate an interest in purchasing the item. The selection of an item by the user may be detected (operation 804). For example, the user may select a radio button when the item is displayed to indicate an interest in purchasing the item or the user may double-click on the item using a mouse, a touchscreen, a voice command, and the like. If more than one item appears in the picture, the user may highlight, select or otherwise indicate the desired item in the picture.

Similarly, a user who encounters an online item, such as a picture of an item, may be offered the ability to indicate an interest in selling the item. For example, the user may select a radio button when the item is displayed to indicate an interest in selling the item. If more than one item appears with the desired item, the user may highlight, select or otherwise indicate the desired item.

In one example embodiment, the selected item and item category may be identified (operation 808). For example, image recognition may be utilized to analyze the image of the item and identify the item. In one example embodiment, social media associated with the users discussing the item may be crawled to seek information that may be useful in identifying the item. For example, a user's description of the item, an identification of a store where the item is available, and the like, may be processed to seek information that may be useful in identifying the item.

In one example embodiment, a search may be conducted for items that are for sale and that are the same as, similar to and/or equivalent to the selected item (operation 812). In response, a list of items available for sale may be returned and may be presented to the user (operation 816). The user may review the item listing and may purchase one or more of the presented items. The purchase selections of the user may be obtained (operation 820).

In one example embodiment, a search may be conducted for items that were available for sale in the past and that are the same as, similar to and/or equivalent to the selected item (operation 824). A measure of interest in the item may be incremented (operation 828). For each item found during operation 824, a corresponding measure of interest in the item may be incremented. For example, a measure of interest in the item may maintain a count of the number of users who expressed interest in the item.

A list of the seller(s) associated with the items identified in operation 824 may then be generated (operation 832). The list may include an identification of the item and a count of users who have expressed an interest in purchasing the item during operation 804.

A test may be performed to determine if the user interest in the item has exceeded a minimum interest threshold (operation 836). For example, if the count of users in the generated list has exceeded a minimum interest threshold, one or more of the sellers on the generated list may be notified of the user interest in purchasing the item (operation 840). For example, electronic mail describing the item of interest and a count of users who have expressed interest in purchasing the item may be sent to one or more of the sellers on the generated list. The communication may include a suggested price or price range for the item. The identities of a number of users that indicated an interest in purchasing the item may be aggregated into a single communication and provided to one or more sellers. For example, the identities of the users that indicated an interest in purchasing the item may be provided to store owners registered with an electronic commerce service. If the count of users in the generated list has not exceeded a minimum interest threshold, the method may end.

In one example embodiment, a test may be performed to determine if an inventory of a seller has been updated to include the cited item (operation 844). If a seller's inventory has been updated to include the item, one or more users who expressed interest in the item may be informed of the availability of the item for purchase (operation 848). For example, if a seller begins offering the item for sale after the user has expressed interest in the item, a notification may be sent to the user. The notification may include the name of the seller, a link to a webpage where the item may be purchased, a description of the item, a price of the item, terms of the offer, and the like.

In one example embodiment, a profile of a user may be modified to indicate that the user has expressed interest in the item identified during operation 808 (operation 852). In one example embodiment, the user may be periodically contacted regarding one or more items in which the user has expressed an interest. A time to remind the user of the interest in the item may be computed (operation 856) and a test may be performed to determine if the time to remind the user has arrived (operation 860). If the time to notify the user has not occurred, the method may repeat operation 860; otherwise the user may be notified of the availability of the item of interest to the user (operation 864). For example, the communication may be sent each time a predefined number of items have been identified by the user, may be sent at a time based on a frequency of a user's purchases, a frequency of the user's online activities, and the like. In one example embodiment, a statistical model may be used to determine when the communication should be sent. For example, the statistical model may be used to determine if the communication should be sent periodically and/or should be sent when one or more of the items is available for sale at a special price. The communication may be sent via electronic mail, electronic text, and the like. The communication may include the name(s) of one or more items, a description of one or more items, one or more pictures of the one or more items, and the like. In one example embodiment, the communication may include a link to a webpage that indicates all of the items that a particular user has indicated an interest in purchasing. For example, the webpage may show a picture of each item. The user may select one of the items to obtain information on purchasing the corresponding item and/or obtain information on purchased items.

In one example embodiment, the owner of the webpage that contains the item of interest to the user may be notified of the user's interest in the item (operation 868). For example, the owner may be notified via electronic mail that the user is interested in the item. In one example embodiment, the owner of the webpage is only notified if the owner is a qualified owner. For example, the owner of the webpage may only be notified if the owner is a non-competitor of the notifier. In one example embodiment, the owner of the webpage is only notified if a minimum interest threshold is exceeded. For example, the owner of the webpage may only be notified if the number of users who have expressed an interest in the item exceeds a predefined threshold.

In one example embodiment, the notification to the owner of the webpage may contain a mechanism for the owner to list the item for sale. For example, the notification may include a link to an electronic commerce service provider for creating an account with the electronic commerce service provider. In one example embodiment, a recommended item listing may be proposed to the owner of the webpage.

In one example embodiment, the webpage owner may be linked to an electronic commerce provider (operation 872).

FIG. 9 is a representation of an example user interface 900 for performing a search for a product, in accordance with an example embodiment. In one example embodiment, the user interface 900 may be utilized by user device 104-1 to enable a user to conduct a search for an item.

In one example embodiment, one or more keywords may be entered in search field 904 and a search button 906 may be selected to initiate the search. The search may be constrained by the search filter settings identified by filter selection indicators 910 in a filter selection area 908. One or more items 920 may be displayed in a search result list area 916. In the example user interface 900, the items in search field 904 are a variety of sets of golf clubs. Golf sets 951, 953, 955 are right-handed golf sets.

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 115.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

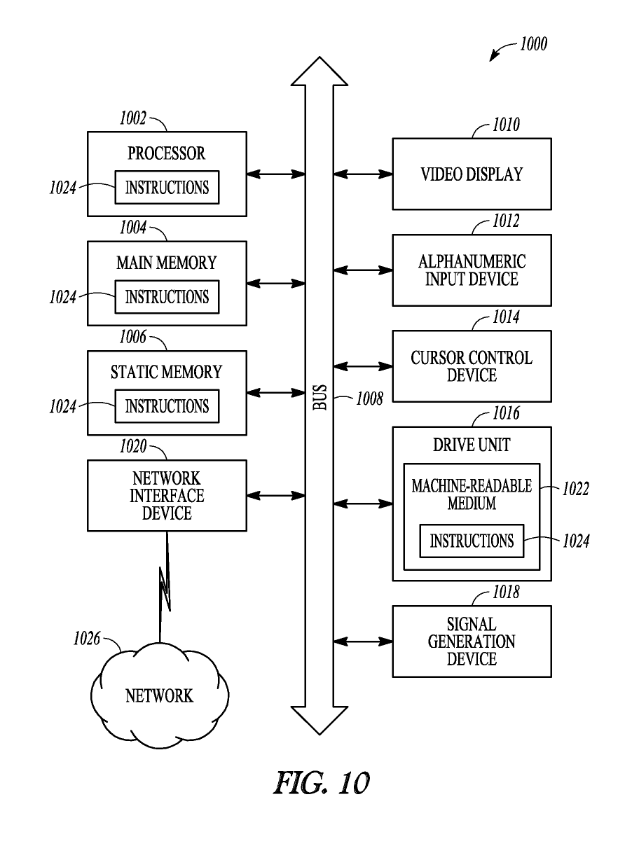

FIG. 10 is a block diagram of a machine within which instructions may be executed for causing the machine to perform any one or more of the methodologies discussed herein. In one example embodiment, the machine may be the example apparatus 300 of FIG. 3 for enhancing electronic commerce using social media. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media 1022. Instructions 1024 may also reside within the static memory 1006.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures 1024. The term “machine-readable medium” shall also be taken to include any tangible medium that is capable of storing, encoding or carrying instructions 1024 for execution by the machine and that cause the machine to perform any one or more of the methodologies of the present invention, or that is capable of storing, encoding or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 1024 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus for performing electronic commerce using social media, the apparatus comprising:
a social media processing module comprising one or more hardware processors, the social media processing module configured to analyze social media information to determine a social media strategy for generating the electronic commerce and define a strategy template based on the determined social media strategy; and
a user interface module configured to provide the strategy template to a user of an electronic commerce service.

2. The apparatus of claim 1, wherein the social media processing module is further configured to:
analyze a structure of a tweet; and
generate a tweet template for creating a promotional tweet to generate electronic commerce.

3. The apparatus of claim 1, wherein the social media processing module is further configured to:
analyze a structure of an online posting; and
generate an online posting template for creating a promotional online posting to generate electronic commerce.

4. The apparatus of claim 2, wherein the tweet template comprises a promotional structure of the promotional tweet, a tone of the promotional tweet, a type of promotional tweet, and a type of call to action.

5. The apparatus of claim 3, wherein the online posting template comprises a promotional structure of the online posting, a tone of the promotional online posting, a type of promotional online posting, and a type of call to action.

6. The apparatus of claim 1, wherein the social media processing module is further configured to rank two or more social media strategies.

7. The apparatus of claim 1, wherein the analysis of the social media information comprises analyzing one or more social media postings that generate the above average rate of electronic commerce transactions.

8. The apparatus of claim 7, wherein the social media processing module is further configured to identify an influencer that issued a social media posting that generated an above average rate of electronic commerce transactions.

9. The apparatus of claim 8, wherein the social media processing module is further configured to map the influencer to one or more categories.

10. The apparatus of claim 9, wherein each category is one of a product category, a service category, a type of influencer category, and a demographic category.

11. The apparatus of claim 9, wherein the social media processing module is further configured to generate a group of users that follow the influencer.

12. The apparatus of claim 9, wherein the social media processing module is further configured to rank two or more influencers by one or more of an amount of generated electronic commerce traffic, a type of generated electronic commerce traffic, a count of new users, and a count of followers.

13. The apparatus of claim 1, wherein the social media processing module is further configured to:
monitor sales of one or more items;
identify one or more of the monitored items as slow-moving items; and
direct online traffic to the one or more slow-moving items.

14. An method for performing electronic commerce using social media, the method comprising:
analyzing social media information to determine a social media strategy for generating the electronic commerce;
defining a strategy template based on the determined social media strategy; and
providing the strategy template to a user of an electronic commerce service.

15. The method of claim 14, further comprising:
analyzing a structure of a tweet; and
generating a tweet template for creating a promotional tweet to generate electronic commerce.

16. The method of claim 14, further comprising:
analyzing a structure of an online posting; and
generating an online posting template for creating a promotional online posting to generate electronic commerce.

17. The method of claim 14, wherein the analysis of the social media information comprises analyzing one or more social media postings that generate an above average rate of electronic commerce transactions.

18. The method of claim 14, further comprising identifying an influencer that issued a social media posting that generated an above average rate of electronic commerce transactions.

19. The method of claim 18, further comprising generating a group of users that follow the influencer.

20. A non-transitory computer-readable medium embodying instructions that, when executed by a processor, perform operations comprising:
analyzing social media information to determine a social media strategy for generating the electronic commerce;
defining a strategy template based on the determined social media strategy; and
providing the strategy template to a user of an electronic commerce service.
